(19) United States
(12) Patent Application Publication
(10) Pub. No.: US 2026/0307505 A1
(43) Pub. Date: Oct. 8, 2026

(54) METHOD FOR OPERATING AN ELECTRIC VEHICLE WITH A DEVICE FOR GENERATING A VIRTUAL SHIFTING SENSATION AND ELECTRIC VEHICLE

(71) Applicant: Dr. Ing. h.c. F. Porsche Aktiengesellschaft, Stuttgart (DE)

(72) Inventors: Markus LINDERMEIER, Vaihingen an der Enz (DE); Benno WIESNER, Fellbach (DE)

(21) Appl. No.: 19/639,317

(22) Filed: Apr. 6, 2026

(30) Foreign Application Priority Data
Apr. 8, 2025 (DE) 10 2025 113 790.0
Nov. 10, 2025 (DE) 10 2025 146 131.7

(51) Int. Cl. B60L 15/20; B60K 17/06; B60K 20/00

(52) U.S. Cl. CPC B60L 15/2054; B60K 17/06; B60K 20/00; B60L 2240/12; B60L 2240/48; B60L 2250/24; B60L 2250/26; B60L 2260/42

(57) ABSTRACT

A method operates an electric vehicle that includes a drive unit including at least one electric motor, a reduction gearbox coupled between the drive unit and an output, the reduction gearbox including shiftable gears, and a shifting simulator configured to perform a virtual shift to generate a virtual shifting sensation. The method includes: performing a real shift in the reduction gearbox; and performing the virtual shift with the shifting simulator to generate the virtual shifting sensation. The real shift of the reduction gearbox and the virtual shift of the shifting simulator are matched to one another.

### CROSS REFERENCE TO RELATED APPLICATIONS

This application claims benefit to German Patent Applications No. DE 10 2025 113 790.0, filed on Apr.8, 2025, and DE 10 2025 146 131.7, filed on Nov.10, 2025, which are hereby incorporated by reference herein.

### FIELD

The present disclosure relates to a method for operating an electric vehicle with a device for generating a virtual shifting sensation. Furthermore, the present disclosure relates to an electric vehicle with a device for generating a virtual shifting sensation.

### BACKGROUND

Electric vehicles are also referred to as battery electric vehicles. The drive unit of an electric vehicle has at least one electric motor, but no combustion engine. In a motor vehicle whose drive unit has a combustion engine, a multi-speed manual gearbox is connected between the internal combustion engine and an output of the motor vehicle, which for reasons of efficiency is increasingly designed as an automatic gearbox. In an automatic gearbox, gear changes are performed automatically based on a driver-side actuation of the accelerator pedal and/or brake pedal. Furthermore, automatic gearboxes are known in which gear changes are also performed manually based on a driver-side actuation of a sequential shift element, such as a shift paddle.

In an electric vehicle, there is no multi-speed manual gearbox between the electric motor and the output; at most, there is a reduction gearbox with typically a single, fixed transmission ratio or also two transmission ratios. Gear changes, as known from motor vehicles with combustion engines and multi-speed manual gearboxes, are not performed in electric vehicles.

Therefore, drivers who switch from a combustion engine vehicle to an electric vehicle typically find the driving experience in an electric vehicle to be less emotional.

As explained above, the drive unit of a motor vehicle designed as an electric vehicle has at least one electric motor but no combustion engine. The electric vehicle has a traction battery in which electrical energy is stored for operating at least one electric motor. In a range extender electric vehicle, the same may be available via an internal combustion engine for charging the traction battery, but the internal combustion engine is not part of the drive unit in a range extender electric vehicle, since even in a range extender electric vehicle, only the at least one electric motor at the drive output of the electric vehicle provides drive power, but not the combustion engine. The same applies to a fuel cell electric vehicle, in which the fuel cell is used to charge the traction battery.

US 2021 / 0 309 113 A1 discloses an electric vehicle with a device for generating a virtual shifting sensation.

DE 10 2022 211 435 A1 discloses another electric vehicle with a device for generating a virtual shifting sensation.

### SUMMARY

In an aspect, the present disclosure provides a method for operating an electric vehicle. The electric vehicle includes a drive unit including at least one electric motor, a reduction gearbox coupled between the drive unit and an output, the reduction gearbox including shiftable gears, and a shifting simulator configured to perform a virtual shift to generate a virtual shifting sensation. The method includes: performing a real shift in the reduction gearbox; and performing the virtual shift with the shifting simulator to generate the virtual shifting sensation. The real shift of the reduction gearbox and the virtual shift of the shifting simulator are matched to one another.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an electric vehicle;

FIG. 2 illustrates a block diagram of assemblies of the electric vehicle; and

FIG. 3 illustrates a further development of FIG. 2.

### DETAILED DESCRIPTION

Aspects of the present disclosure provide a method for operating an electric vehicle and an electric vehicle. Aspects of the present disclosure provide technical enhancements that modify vehicle operation to make the driving experience more emotional in an electric vehicle whose reduction gearbox has at least two, in preferred aspects two, shiftable gears with different gear ratios.

According to an aspect of the present disclosure, in an electric vehicle, the reduction gearbox of which comprises at least two, preferably two, shiftable gears, and which further comprises a device for generating a virtual shifting sensation (also referred to herein as a shifting simulator), real shifts in the reduction gearbox and virtual shifts of the device for generating the virtual shifting sensation are matched to one another. According to an aspect of the present disclosure, real shifts in the reduction gearbox of the electric vehicle and virtual shifts of the device for generating the virtual shifting sensation be matched to one another. This can guarantee a particularly emotional driving experience in an electric vehicle.

In a preferred aspect, when the device for generating a virtual shifting sensation is activated, real shifts and virtual shifts are matched to one another such that real shifts and virtual shifts are performed at the same time, in particular, such that a shift duration of a real shift corresponds to a shift duration of a virtual shift, and/or that, if a real shift and a virtual shift are performed at the same time, a torque intervention at the output of the electric vehicle corresponds to the torque intervention of a purely virtual shift.

This is particularly preferred in order to ensure an emotional driving experience in an electric vehicle, in which, on the one hand, real shifts are performed in the reduction transmission and, on the other hand, virtual shifts are additionally performed by the device for generating the virtual shifting sensation.

In a preferred aspect, when the device for generating a virtual shifting sensation is activated and when a real shift in the reduction gearbox is requested as a result of reaching a speed range, execution of the real shift is blocked until the respective virtual shift is performed by the device for generating the virtual shifting sensation. This is particularly preferred for coordinating or synchronizing real shifts and virtual shifts to provide an emotional driving experience.

In a preferred aspect, when the device for generating a virtual shifting sensation is activated and when a real shift in the reduction gearbox is requested as a result of a torque request or power request, a corresponding virtual shift is forcibly performed by the device for generating the virtual shifting sensation at the same time as the real shift in the reduction gearbox. This is also particularly preferred for coordinating or synchronizing real shifts and virtual shifts to provide an emotional driving experience.

In a preferred aspect, the device for generating the virtual shifting sensation is configured to be operated in an automatic operating mode or shift mode or in a sequential operating mode or shift mode, wherein in the automatic operating mode or shift mode, for generating a virtual automatic shifting sensation, virtual shifts are performed as a function of a driver-side actuation of an accelerator pedal and/or a driver-side actuation of a brake pedal, and in the sequential operating mode or shift mode, to generate the virtual sequential shifting sensation, virtual shifts are performed as a function of a driver-side actuation of sequential shift elements. Both in the automatic operating mode or shift mode as well as in the sequential operating mode or shift mode of the device for generating the virtual shifting sensation, real shifts and virtual shifts are matched to one another. This is particularly preferred in order to increase the emotionality of the driving experience.

Then, when the device for generating the virtual shifting sensation is configured to be operated in a manual operating mode or shift mode, in the manual operating mode or shift mode of the device for generating the virtual shifting sensation, real shifts and virtual shifts are also matched to one another. This is also particularly preferred in order to increase the emotionality of the driving experience.

Preferred further aspects of the present disclosure are disclosed in the description that follows. Embodiment examples of the present disclosure will be explained in greater detail with reference to the drawings, but without being restricted thereto.

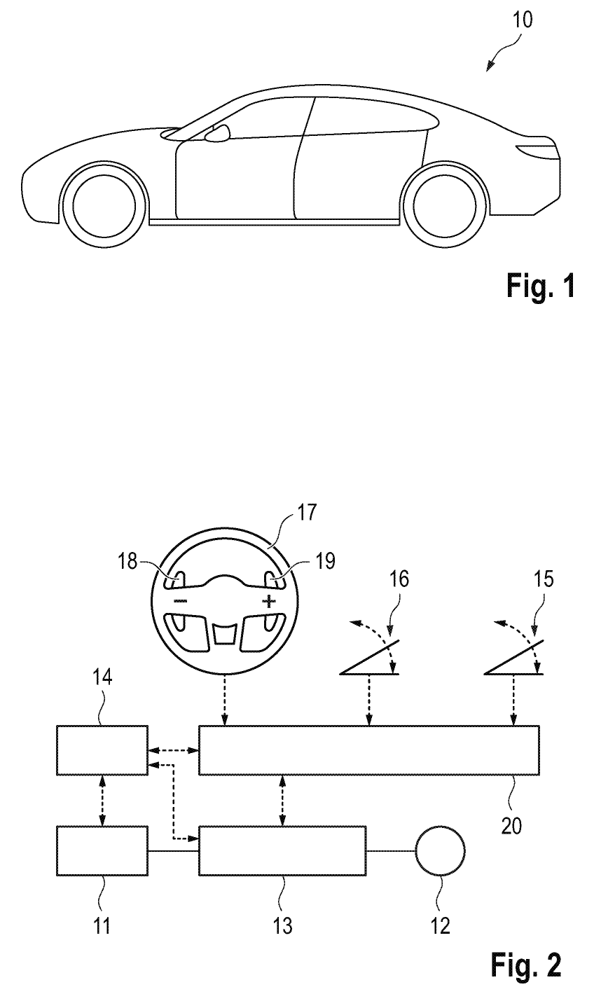

FIG. 1 shows a motor vehicle configured as an electric vehicle 10. In an electric vehicle 10, a drive unit thereof has at least one electric motor 11, but no internal combustion engine. It is possible that the drive unit of the electric vehicle 10 has a single electric motor 11, which then drives an axle of the electric vehicle 10. The drive unit of the electric vehicle 10 may also comprise several electric motors 11. For example, with two driven axles of the electric vehicle 10, each of the driven axles may be assigned an individual electric motor 11, wherein the electric vehicle 10 then has two electric motors 11. Each driven wheel of the electric vehicle 10 can also be assigned an individual electric motor 11, in which case the number of electric motors 11 of the drive unit of the electric vehicle 10 corresponds to the number of driven wheels of the electric vehicle 10.

The number of electric motors 11 in the drive unit of the electric vehicle 10 is purely illustrative.

FIG. 2 shows highly schematized assemblies of an electric vehicle 10, namely an electric motor 11, which provides drive power to a drive output 12 of the electric vehicle 10. In an electric vehicle 10, unlike combustion engine-powered motor vehicles, there is no multi-speed manual gearbox between the electric motor 11 and the drive output 12, rather a reduction gearbox 13.

The reduction gearbox 13, in a preferred aspect, has two gear ratios and thus two real gears, between which shifting can be performed. The reduction gearbox 13 may also have three gear ratios or three real gears. Accordingly, in electric vehicles 10, gear changes are not performed based on driver-side actuation of the accelerator pedal and/or based on driver-side actuation of a brake pedal of the electric vehicle 10 in a multi-gear transmission, as is known from internal combustion engines. This restricts the driving experience of an electric vehicle 10. In order to enhance the driving experience of an electric vehicle 10, an electric vehicle 10 according aspects of the present disclosure includes a device (which is also referred to herein as a shifting simulator) 14 for generating a virtual shifting sensation.

The device 14 for generating the virtual shifting sensation can simulate a virtual gearbox with virtual shifts by the device 14 controlling the at least one electric motor 11 of the electric vehicle 10 such that the at least one electric motor 11 provides a torque profile at the output 12 of the electric vehicle 10 that corresponds to a torque profile that would be formed when gear changes are performed in combustion engine-driven motor vehicles with a multi-speed manual gearbox.

When the device 14 for generating the virtual shifting sensation is deactivated, the electric vehicle 10 is operated like a conventional electric vehicle without performing virtual shifting.

If, on the other hand, the device 14 for generating the virtual shifting sensation is activated, it generates a virtual shifting sensation for a driver.

The device 14 for generating the virtual shifting sensation can, in the exemplary embodiment of FIG. 2, preferably generate either a virtual automatic shifting sensation in a first automatic operating mode or shift mode or a virtual sequential shifting sensation in second sequential operating mode.

In the first automatic operating mode or shift mode of the device 14 for generating the virtual shifting sensation, the device 14 simulates the presence of an automatic, multi-speed manual gearbox such that the device 14 for generating a virtual shifting sensation, as a function of the driver’s actuation of an accelerator pedal 15 and/or or as a function of the driver’s actuation of a brake pedal 16, performs virtual automatic shifting, and by controlling the electric machine 11 at the drive output 12, it provides a torque curve that would be formed at the output 12 if an automatic multi-speed manual gearbox were present.

The torque curve to be provided at the drive output 12 of the electric vehicle 10 in the first, automatic operating mode of shift mode of the device 14 for generating the virtual shifting sensation can be determined based on the actuation of the accelerator pedal 15 and/or based on the actuation of the brake pedal 16 as a function of characteristic curves, in particular aspects also based on a virtual current gear and virtual target gear of the virtual shift.

By contrast, on the other hand, when the second sequential operating mode or shift mode of the device 14 for generating the virtual shifting sensation is activated, the device 14 generates a virtual sequential shifting sensation, based in particular aspects on driver-side actuation of sequential shifting elements 18, 19 installed on a steering wheel 17 of the electric vehicle, which are configured as shifting paddles or shifting rocker switches in the shown exemplary embodiment. If the second sequential operating mode or shift mode of the device 14 for generating the virtual shifting sensation is activated, the device 14 for generating the virtual shifting sensation, as a function of the driver-side actuation of the sequential shifting element 18, 19, actuates the electric motor 11 such that it performs the same virtual sequential shifts and provides a torque curve at the drive output 12 that would develop if a multi-speed manual gearbox operated in sequential shift mode were present in the electric vehicle 10.

The torque curve to be provided at the drive output 12 in the second, sequential operating mode or shift mode of the device 14 for generating the virtual shifting sensation can be determined based on the actuation of the respective sequential shift element 18, 19 as a function of characteristic curves.

The device 14 for generating the virtual shifting sensation simulates the presence of a multi-speed manual gearbox based on the operating mode or shift mode of the same. When the device 14 for generating the virtual shifting sensation is activated, it can, in preferred aspects, be operated in two operating modes, namely, as described above, in the first automatic operating mode or shift mode, in the second sequential operating mode or shift mode. Accordingly, when the device 14 for generating the virtual shifting sensation is deactivated, the electric vehicle 10 behaves like a conventional electric vehicle, and no virtual shifts are simulated, and no virtual shifting sensation is provided.

If, on the other hand, the device 14 for generating the virtual shifting sensation is activated, it provides a virtual shifting sensation as a function of the activated operating mode or shift mode by executing virtual shifts, simulating a virtual gearbox, in particular aspects by the device 14 for generating the virtual shifting sensation controlling the electric motor 11 such that it provides a torque curve at the output 12 as would be formed when a gear change is performed in a multi-speed manual gearbox of a combustion engine vehicle.

As has already been discussed, virtual shifts are performed by the device 14 for generating the virtual shifting sensation in order to simulate a virtual transmission. Particularly in the automatic operating mode or shift mode, a virtual speed of a virtual internal combustion engine is simulated by the device 14 for generating the virtual shifting sensation, as well as a virtual torque of the virtual internal combustion engine.

The device 14 for generating the virtual shifting sensation simulates not only a virtual gearbox but also a virtual internal combustion engine, based on whose virtual speed and/or virtual torque virtual shifts are performed, in particular aspects in the automatic operating mode or shift mode. If, in automatic operating mode or shift mode, virtual shift points are reached by the virtual speed and/or the virtual torque of the virtual combustion engine based on the driver-side actuation of the accelerator pedal and/or brake pedal, virtual shifts can be performed.

The virtual speed of the virtual internal combustion engine can be simulated by calculating the virtual speed of the virtual internal combustion engine based on a driving speed or engine speed at the output 12 of the electric vehicle 10 or the engine speed or the electric motor 10 known on the control side and based on the virtual transmission of an engaged virtual gear.

Based on the virtual speed of the virtual internal combustion engine calculated in this way, a virtual torque of the virtual internal combustion engine can be determined in a map-based or characteristic curve-dependent manner, namely based on a virtual engine map of the virtual internal combustion engine. In automatic operating mode or shift mode, virtual shifts are therefore performed automatically based on virtual shift points of a virtual shift strategy, wherein the virtual shift points depend in particular on the virtual combustion engine speed and/or its virtual torque.

As already stated above, the electric vehicle 10 comprises, firstly, the reduction gearbox 13 with preferably two shiftable gears, and furthermore, the device 14 for generating the virtual shifting sensation. In the device 14 for generating the virtual shifting sensation, as discussed above, virtual shifts may be performed as a function of driver-side actuation of the accelerator pedal 15 and/or as a function of driver-side actuation of the brake pedal 16 and/or as a function of driver-side actuation of the sequential shift elements 18, 19. Shifts between gears of the reduction gearbox 13 may also be performed as a function of driver-side actuation of the accelerator pedal 15 and/or the brake pedal 16 and/or the sequential shift elements 18, 19.

By means of a device 20, data dependent on actuation of the accelerator pedal 15 and actuation of the brake pedal 16 and actuation of the sequential shift elements 18, 19 may be provided to the reduction gearbox 13 as well as to the device 14 for generating the virtual shifting sensation, wherein the reduction gearbox 13 and the device 14 for generating the virtual shifting sensation also exchange data with each other.

According to an aspect of the present disclosure, real shifts of the reduction gearbox 13 and virtual shifts of the device 14 for generating the virtual shifting sensation are matched to one another. When the device 14 for generating the virtual shifting sensation is activated, real shifts are performed in the reduction gearbox 13 only when a corresponding or correlating virtual shift is performed by the device 14 for generating the virtual shifting sensation at the same time. If the device 14 for generating the virtual shifting sensation generation is deactivated, no virtual shifts are performed, but real shifts may be performed in the reduction gearbox 13.

Real shifts of the reduction gearbox 13 and virtual shifts of the device 14 for generating the virtual shifting sensation are matched to one another, in particular aspects, when the device 14 for generating the virtual shifting sensation is activated such that real shifts and virtual shifts are performed at the same time, wherein a shift duration of a real shift corresponds to the shift duration of a virtual shift. Then, when real shifts and virtual shifts are performed at the same time, the torque intervention at the output 12 provided by the device 14 for generating the virtual shifting sensation is reduced compared to a purely virtual shift. Thus, in a purely virtual shift, the torque intervention at the output 12, which is then provided exclusively by the device 14 for generating the virtual shifting sensation via a corresponding drive of the electric machine 11, is to correspond to the torque intervention that then occurs when a real shift and virtual shift are performed at the same time. Thus, a defined torque intervention at the output 12 is already provided by a real shift in the reduction gearbox 13 in order to reduce the torque intervention of the device 14 for generating the virtual shifting sensation compared to a purely virtual shift, in order to provide an identical torque intervention at the output 12, regardless of whether a purely virtual shift is performed or a virtual shift and a real shift are performed at the same time.

In particular aspects, when the device 14 for generating the virtual shifting sensation is activated, it is provided to perform real shifts in the reduction gearbox 13 and virtual shifts of the device 14 for generating the virtual shifting sensation dependent on monitoring the virtual engine speed of the virtual internal combustion engine, wherein shifts are then performed when the virtual engine speed reaches a virtual speed range. In this context, it is preferably provided that, when the device for generating the virtual shifting sensation is activated, execution of a real shift in the reduction gearbox 13 as a result of reaching a virtual speed range is blocked until a corresponding or correlating virtual shift is performed by the device 14 for generating the virtual shifting sensation. The real shift in the reduction gearbox 13 and the corresponding virtual shift of the device 14 for generating the virtual shifting sensation are then performed at the same time.

Then, when a real shift is requested in the reduction gearbox 13 as a result of a torque or power request as a function of the actuation of the accelerator pedal 15 and/or the actuation of the brake pedal 16, when the device 14 for generating the virtual shift sensation is activated, a virtual shift is forcibly performed by the device 14 for generating the virtual shift sensation at the same time as the real shift in the reduction gearbox 13.

In a specific exemplary embodiment, it is to be assumed that the reduction transmission 13 of the electric vehicle 10 comprises two real gear ratio stages and accordingly two real gears, namely a first real gear 1R and a second real gear 2R. Furthermore, in the specific exemplary embodiment, it is assumed that the device 14 for generating the virtual shifting sensation of the electric vehicle 10 may provide eight virtual gears 1V, 2V, 3V, 4V, 5V, 6V, 7V, and 8V.

Furthermore, in the specific exemplary embodiment, it is assumed that the virtual gears 1V and 2V can be used in a speed range, in which the real first gear 1R is effective in the reduction gearbox 13. The virtual gears 3V, 4V, 5V, 6V and 7V can be utilized in a speed range, in which the real second gear 2R is effective in the reduction gearbox 13.

Accordingly, for the specific exemplary embodiment, with a virtual shift of the device 14 for generating the virtual shift sensation from virtual gear 1V to virtual gear 3V, or in a virtual shift from virtual gear 2V to virtual gear 3V, a real shift in the reduction gearbox 13 is to be performed from real first gear 1R to real second gear 2R.

Likewise, for the specific exemplary embodiment, with a virtual shift of the device 14 for generating the virtual shift sensation from the virtual gear 3V to the virtual gear 2V, or even with a virtual shift from the virtual gear 3V to the virtual gear 1V in the reduction gearbox 13, a real shift is to be performed from the real second gear 2R to the real first gear 1R.

Such real shifts in the reduction gearbox 13 and virtual shifts of the device 14 for generating the virtual shifting sensation may be synchronized.

A virtual shift of the device 14 for generating the virtual shifting sensation from the virtual gear 5V to the virtual gear 6V or a virtual shift of the device 14 from the virtual gear 3V to the virtual gear 4V does not require any real shift in the specific embodiment, since, in these virtual gears 3V, 4V, 5V, 6V , the real second gear 2R is effective in the reduction gearbox 13.

Then, if the device 14 for generating the virtual switching sensation is activated in the automatic operating mode or shift mode and a virtual upshift is requested as a function of the driver-side actuation of the accelerator pedal 15 and/or as a function of the driver-side actuation of the brake pedal 16, a corresponding real upshift is then performed in the reduction gearbox 13 at the same time as the virtual upshift, if a virtual engine speed is within a virtual speed range for the target gear of the real upshift, and if, according to a first alternative, a speed of the electric vehicle is greater than a first limit value or, according to a second alternative, the speed of the electric vehicle is less than a second limit value, and additionally the driver-side actuation of the accelerator pedal 15 is less than a third limit value.

This occurs in the case of the specific exemplary embodiment, for example, if there is a virtual upshift from virtual gear 2V to virtual gear 3V and at the same time a real upshift is performed in reduction gearbox 13 from real first gear 1R to real second gear 2R.

Then, if the device 14 for generating the virtual shifting sensation in the automatic operating mode or shift mode is activated and, as a function of the driver-side actuation of the accelerator pedal 15 and/or the driver-side actuation of the brake pedal 16, a virtual downshift is requested, a corresponding real downshift in the reduction gearbox 13 is then performed at the same time as the virtual downshift of the device 14 for generating the virtual shifting sensation, if a virtual engine speed is within a virtual speed range for the target gear of the real downshift, and if, according to a first alternative, a speed of the motor vehicle is less than a fourth limit value or, according to a second alternative, the driver-side actuation of the accelerator pedal 15 is greater than a fifth limit value.

This occurs in the case of the specific exemplary embodiment, for example, if there is a virtual downshift from virtual gear 3V to virtual gear 2V and at the same time a real downshift in reduction gearbox 13 from real first gear 2R to real second gear 1R is performed.

The above limit values, i.e., the first and/or the second and/or the third and/or the fourth and/or the fifth limit value, may be dependent on the driving mode chosen. The driving mode may be an eco-driving mode, a sport-driving mode, a performance-driving mode, or a race-driving mode, for example. Depending on the driving mode, limit values may be selected such that real shifts in the reduction gearbox 13 are omitted.

The determination of the above limit values, i.e., the first and/or second and/or third and/or fourth and/or fifth limit values, as a function of the selected driving mode, may be carried out as a function of the characteristic curves.

Then, if the device 14 for generating the virtual shifting sensation is activated in the sequential operating mode or shift mode and a virtual upshift is requested as a function of the driver-side actuation of the sequential shifting element 19, a real upshift is then performed in the reduction gearbox 13 at the same time as the virtual upshift, when a virtual upshift is performed or occurs from a current virtual gear, in which a first gear of the reduction gearbox 13 is effective, to a virtual target gear, in which a second gear of the reduction gearbox 13 is effective.

This occurs in the specific exemplary embodiment if, in the sequential operating mode or shift mode, for example, a virtual upshift from gear 2V to gear 3V is requested, such that a real upshift from real gear 1R to real gear 2R is then performed at the same time in the reduction gearbox 13.

Then, if the device 14 is activated in the sequential operating mode or shift mode and a virtual downshift is requested by the driver-side actuation of the sequential shifting element 18, a corresponding real downshift is performed in the reduction gearbox 13 at the same time as the virtual downshift, when the virtual downshift is performed or occurs from a current virtual gear, in which the second gear of the reduction gearbox 13 is effective, to a virtual target gear, in which the first gear of the reduction gearbox 13 is effective.

This occurs in the specific exemplary embodiment if, in the sequential operating mode or shift mode, for example, a virtual downshift from virtual gear 3V to virtual gear 2V is requested, such that a real downshift from first real gear 2R to second real gear 1R is then performed at the same time in the reduction gearbox 13.

In a further development of the present disclosure, it is provided that, if the device 14 for generating the virtual shifting sensation is activated in the automatic operating mode or shift mode, and in particular as a result of a driver-side torque request or power request, a real upshift of the reduction gearbox 13 is requested, a respective virtual upshift is then performed at the same time as the real upshift, if the virtual engine speed is within a virtual speed range for the target gear of the upshift, and if, according to a first alternative, a speed of the electric vehicle 10 is greater than a sixth limit value or, according to a second alternative, the speed of the electric vehicle is less than a seventh limit value, and additionally the driver-side actuation of the accelerator pedal 15 is less than an eighth limit value. This occurs in the case of the specific exemplary embodiment, for example, when a real upshift from gear 1R to gear 2R is performed. The real upshift will then occur at the same time as a virtual upshift.

Likewise, if the device 14 for generating the virtual shifting sensation is activated in the automatic operating mode or shift mode, and in particular embodiments, as a result of a driver-side torque request or power request, a real downshift of the reduction gearbox 13 is requested, a respective virtual downshift is then performed by the device 14 at the same time as the real downshift in the reduction gearbox 13, if a virtual engine speed is within a virtual speed range for the target gear of the downshift and if, according to a first alternative, a speed of the electric vehicle 10 is less than a ninth limit value or, according to a second alternative, the driver-side actuation of the accelerator pedal 15 is greater than a tenth limit value. This occurs in the case of the specific exemplary embodiment, for example, when a real downshift from gear 2R to gear 1R is performed. The real downshift then occurs at the same time as a virtual downshift.

These limit values stated above, i.e., the sixth limit value and/or the seventh limit value and/or the eighth limit value and/or the ninth limit value and/or the tenth limit value, may again be dependent on the driving mode, in particular on characteristic curves. The driving mode may be an eco-driving mode, a sport-driving mode, a performance-driving mode, or a race-driving mode, for example. Depending on the driving mode, limit values may be selected so that they are omitted.

Then, when the device for generating the virtual shifting sensation is activated in the sequential operating mode or shift mode and a real upshift of the reduction gearbox 13 or a real downshift of the reduction gearbox 13 is requested, a virtual upshift or a virtual downshift of the device 14 for generating the virtual shifting sensation, and thus also the real upshift or the real downshift, is prevented.

This prevention of the respective shifting operation is carried out for an upshift as long as the sequential operating mode or shift mode is activated and no virtual upshift is requested by the driver. For a downshift, the respective shifting is prevented as long as the sequential operating mode or shift mode is activated and no virtual downshift is requested either by the driver or by a virtual shift controller when the virtual engine speed is less than a speed limit.

In a further development, it may be provided to adjust the shift strategy of the reduction gearbox 13 so as to depend on the driving mode, such that, when an Eco driving mode is selected for the electric vehicle 10, starting of the electric vehicle 10 is carried out with the second real gear 2R engaged in the reduction gearbox 13, whereas, when the sport driving mode or performance driving mode or race driving mode is selected as the driving mode, starting occurs with the first real gear 1R engaged in the reduction gearbox 13.

In the Eco driving mode, overrun downshifts in the reduction gearbox 13 may be prevented. In the sport driving mode, overrun downshifts in the real reduction gearbox 13 occur when the vehicle speed is less than a corresponding limit value. This may also occur in the race driving mode.

In the performance driving mode, although overrun downshifts of the reduction gearbox 13 are preferably permitted, traction downshifts of the reduction gearbox 13 are not.

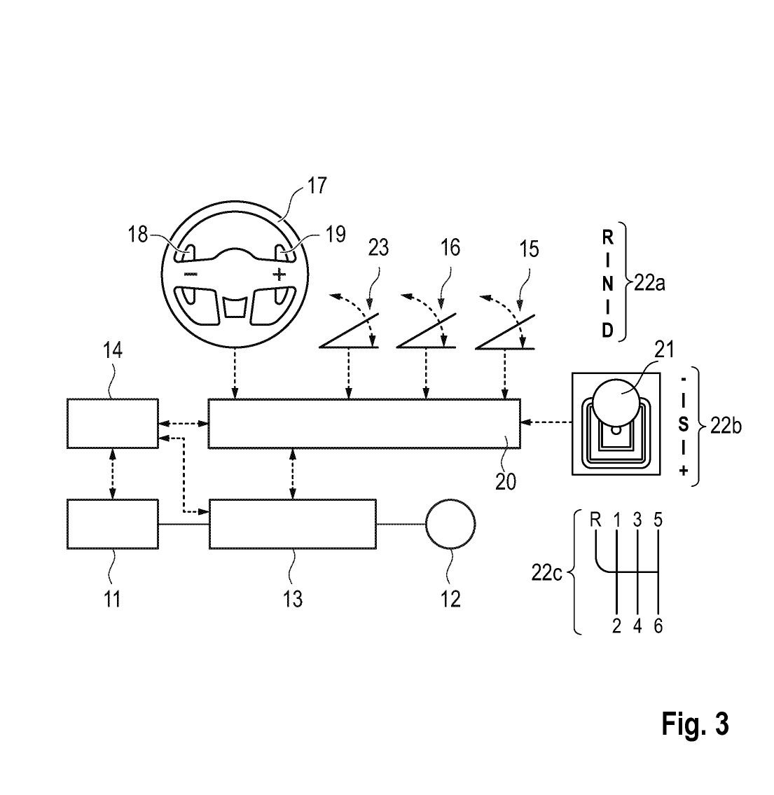

FIG. 3 shows a further development of FIG. 2. In the further development of FIG. 3, the same reference numerals are used for the same assemblies as in FIG. 2, wherein reference is made to the corresponding explanations of FIG. 2 in order to avoid unnecessary repetitions for FIG. 3. Only such details will be discussed below by which the exemplary embodiment of FIG. 3 differs from the exemplary embodiment of FIG. 2.

In FIG. 3, the device 14 for generating the virtual shifting sensation can be operated in the automatic operating mode or shift mode, in the sequential operating mode or shift mode, and additionally also in a manual operating mode or shift mode. In the sequential operating mode or shift mode in FIG. 3, a shift lever 21 installed in the area of a center console can also be used as a sequential shifting element.

When the manual operating mode or shift mode of the device 14 for generating the virtual shifting sensation is activated, as in FIG. 3, the device 14 generates a virtual manual shifting sensation based on a driver-side actuation of the shift lever 21 installed in the region of the center console as well as based on a driver-side actuation of a foot pedal serving as a virtual clutch pedal 23.

If the manual operating mode or shift mode of the device 14 for generating the virtual shifting sensation is activated, then, based on the driver-side actuation of the shift lever 21 and based on the driver-side actuation of the foot pedal serving as a virtual clutch pedal 23, the device 14 for generating the virtual shifting sensation controls the electric motor 11 such that, when virtual shifts are performed at the drive output 12 by the electric motor 11, a torque or torque curve is provided which would be generated if a multi-speed manual gearbox were present in the electric vehicle 10.

The torque profile to be provided in manual operating mode or shift mode at the output 12 can be determined in a map-based manner based on the actuation of the shift lever 21 and based on the driver-side actuation of the foot pedal serving as the virtual clutch pedal 23.

In the automatic operating mode or shift mode of the device 14 for generating the virtual shifting sensation, automatic virtual shifts are triggered based on the driver-side actuation of the accelerator pedal 15 and/or the brake pedal 16, wherein, the shift lever 21 serves as the travel direction selection element. For example, FIG. 3 shows a shift gate 22a for the shift lever 21, which is activated for the shift lever 21 in the automatic operating mode or shift mode in order to select either the forward drive stage D or the reverse travel stage R or neutral N via the shift lever 21 in the automatic shift mode.

In the sequential operating mode or shift mode of the device 14 for generating the virtual shifting sensation, sequential shifts are triggered based on the driver-side actuation of at least one sequential shift element, wherein the shift lever 21 can also be used as a sequential shift element. The shift gate 22b of FIG. 3 is activated for the shift lever 21 in the sequential operating mode or shift mode in order to then request sequential virtual up-shifts and sequential virtual down-shifts via the shift lever 21 for the device 14 for generating the virtual shifting sensation in the sequential shift mode.

In the manual operating mode or shift mode of the device 14 for generating the virtual shifting sensation, the shift gate 22c of FIG. 3 is activated for the shift lever 21, with a plurality of forward gear shift lanes and a downshift lane interconnected via a middle lane. In the manual operating mode or shift mode of the device 14 for generating the virtual shifting sensation, the shift lever 21 can be displaced by the driver along the shift gate 22c when the virtual clutch pedal 23 is actuated, in order for the driver to trigger or request manual shifts. Six forward gears and one reverse gear can be selected via the shift gate 22c of FIG. 3.

Then, if the device 14 for generating the virtual shifting sensation is activated in the manual operating mode or shift mode and a virtual upshift is requested as a function of the driver-side actuation of the shift lever 21, a real upshift is then performed in the reduction gearbox 13 at the same time as the virtual upshift, when a virtual upshift is performed or occurs from a current virtual gear, in which a first gear of the reduction gearbox 13 is effective, to a virtual target gear, in which a second gear of the reduction gearbox 13 is effective.

This occurs in the specific exemplary embodiment if, in the manual operating mode or shift mode, for example, a virtual upshift from gear 2V to gear 3V is requested, such that a real upshift from real gear 1R to real gear2R is then performed at the same time in the reduction gearbox 13.

Then, if the device 14 is activated in the manual operating mode or shift mode and a virtual downshift is requested by the driver-side actuation of the shift lever 21, a corresponding real downshift is performed in the reduction gearbox 13 at the same time as the virtual downshift, when the virtual downshift is performed or occurs from a current virtual gear, in which the second gear of the reduction gearbox 13 is effective, to a virtual target gear, in which the first gear of the reduction gearbox 13 is effective.

This occurs in the specific exemplary embodiment if, in the manual operating mode or shift mode, for example, a virtual downshift from virtual gear 3V to virtual gear 2V is requested, such that a real downshift from first real gear 2R to second real gear 1R is then performed at the same time in the reduction gearbox 13.

Then, when the device 14 for generating the virtual shifting sensation is activated in the manual operating mode or shift mode and a real upshift of the reduction gearbox 13 or a real downshift of the reduction gearbox 13 is requested, a virtual upshift or a virtual downshift of the device 14 for generating the virtual shifting sensation, and thus also the real upshift or the real downshift, is prevented, namely, for an upshift as long as the manual operating mode or shift mode is activated and no virtual upshift is requested by the driver, and for a downshift as long as the manual operating mode or shift mode is activated and a virtual downshift is not requested either by the driver or by a virtual shift controller when the virtual engine speed is less than a speed limit.

Aspects of the present disclosure relate to an electric vehicle 10 with a drive unit comprising at least one electric motor 11, with a reduction gearbox 13 coupled between the drive unit 11 and the output 12 and with at least two, preferably two, real gears, as well as to the device 14 for generating the virtual shift sensation.

A control unit of the electric vehicle 10 is configured to match the real shifts of the reduction gearbox 13 and the virtual shifts of the device 14 for generating the virtual shift sensation with one another, wherein this control unit may be the device 14 for generating the virtual shift sensation, a control unit of the reduction gearbox 13, or also a separate control unit. The control unit is configured to perform a method of the present disclosure.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for operating an electric vehicle, the electric vehicle comprising a drive unit comprising at least one electric motor, a reduction gearbox coupled between the drive unit and an output, the reduction gearbox comprising shiftable gears, and a shifting simulator configured to perform a virtual shift to generate a virtual shifting sensation, the method comprising:
performing a real shift in the reduction gearbox; and
performing the virtual shift with the shifting simulator to generate the virtual shifting sensation,
wherein the real shift of the reduction gearbox and the virtual shift of the shifting simulator are matched to one another.

2. The method according to claim 1, the method further comprising:
activating the shift simulator for generating the virtual shifting sensation; and
based on the shift simulator being activated, performing the real shift in the reduction gearbox only at a same time that the virtual shift is performed by the shifting simulator.

3. The method according to claim 1, the method further comprising:
activating the shift simulator;
requesting the real shift in the reduction gearbox as a result of reaching a speed range; and
blocking an execution of the real shift until the virtual shift is performed by the shift simulator.

4. The method according to claim 1, the method further comprising:
activating the shifting simulator;
requesting the real shift in the reduction gearbox as a result of a torque request or a power request; and
forcibly performing the virtual shift by the shifting simulator at a same time as the real shift in the reduction gearbox.

5. The method according to claim 1, wherein the real shift and the virtual shift are matched to one another such that the real shift and the virtual shift are performed at a same time.

6. The method according to claim 1, wherein the real shift and the virtual shift are matched to one another such that a shift duration of the real shift corresponds to a shift duration of the virtual shift.

7. The method according to claim 1, wherein the real shift and the virtual shift are matched to one another such that, based on the real shift and the virtual shift being performed at a same time, a torque intervention on the output corresponds to a torque intervention of an exclusively virtual shift.

8. The method according to claim 1, wherein the shifting simulator is configured to be operated in an automatic operating mode or in a sequential operating mode, the method further comprising:
performing, in the automatic operating mode, the virtual shift for generating a virtual automatic shifting sensation as a function of a driver-side actuation of an accelerator pedal and/or a driver-side actuation of a brake pedal; and
performing, in the sequential operating mode, the virtual shift for generating a virtual sequential shifting sensation as a function of a driver-side accelerator actuation of sequential shift element, and
wherein the real shift and the virtual shift are matched to one another in both the automatic operating mode and the sequential operating mode of the device for generating the virtual shifting sensation.

9. The method according to claim 8, wherein the shifting simulator is further configured to be operated in a manual operating mode, the method further comprising:
performing, in the manual operating mode, the virtual shift a function of a driver-side actuation of a virtual clutch pedal and a shift lever, and wherein, in the manual operating mode of the device for generating the virtual shifting sensation, the real shift and the virtual shift are matched to one another.

10. The method according to claim 8, further comprising:
activating the shifting simulator in the automatic operating mode;
requesting a virtual upshift as the function of the driver-side actuation of the accelerator pedal and/or the driver-side actuation of the brake pedal; and
performing a real upshift corresponding to the virtual upshift in the reduction gearbox at a same time as the virtual upshift based on a virtual engine speed being within a virtual speed range for a target gear of the real upshift, a speed of the electric vehicle being greater than a first limit value or less than a second limit value, and the driver-side actuation of the accelerator pedal being less than a third limit value.

11. The method according to claim 10, further comprising:
activating the shifting simulator in the automatic operating mode;
requesting a virtual downshift as the function of the driver-side actuation of the accelerator pedal and/or the driver-side actuation of the brake pedal; and
performing a real downshift corresponding to the virtual downshift at a same time as the virtual downshift, based on a virtual engine speed being within a virtual speed range for the target gear of the downshift, and based on either a speed of the electric vehicle being less than a fourth limit value or the driver-side actuation of the accelerator pedal being greater than a fifth limit value.

12. The method according to claim 11, wherein the first limit value, the second limit value, the third limit value, the fourth limit value, or the fifth limit value is dependent on the driving mode.

13. The method according to claim 8, the method further comprising:
activating the shifting simulator in the sequential operating mode or the manual operating mode;
requesting a virtual upshift as a function of the driver-side actuation of a sequential shift element; and
performing a real upshift corresponding to the virtual upshift at a same time as the virtual upshift is performed, wherein the virtual upshift is from a virtual current gear, in which a first gear ratio or first gear of the reduction gearbox is effective, into a virtual target gear, in which a second gear ratio or second gear of the reduction gearbox is effective.

14. The method according to claim 8, further comprising:
activating the shifting simulator in the sequential operating mode or the manual operating mode;
requesting a virtual downshift as the function of the driver-side actuation of the sequential shift element; and
performing a real downshift corresponding to the virtual downshift at a same time as the virtual downshift is performed, wherein the virtual downshift is from a virtual current gear, in which the second gear ratio or second gear of the reduction gearbox is effective, into a virtual target gear, in which the first gear ratio or first gear of the reduction gearbox is effective.

15. The method according to claim 8, further comprising:
activating the shifting simulator in the automatic operating mode;
requesting a real upshift of the reduction gearbox; and
performing a corresponding virtual upshift at a same time as the real upshift, based on a virtual engine speed being within a virtual speed range for the target gear of the upshift, and based on either a speed of the electric vehicle being greater than a sixth limit value or being less than a seventh limit value, and based on the driver-side actuation of the accelerator pedal being less than an eighth limit value.

16. The method according to claim 15, further comprising:
activating the shifting simulator in the automatic operating mode;
requesting a real downshift of the reduction gearbox; and
performing a corresponding virtual downshift at a same time as the real downshift, based on a virtual engine speed being within a virtual speed range for the target gear of the downshift, and based on either a speed of the electric vehicle being less than a ninth limit value or the driver-side actuation of the accelerator pedal being greater than a tenth limit value.

17. The method according to claim 16, wherein the sixth limit value, the seventh limit value, the eighth limit value, the ninth limit value, or the tenth limit value are dependent on the driving mode.

18. The method according to claim 8, further comprising:
activating the shifting simulator in the sequential operating mode or the manual operating mode;
requesting a real upshift of the reduction gearbox; and
blocking or preventing a virtual upshift of the shifting simulator and the real upshift of the reduction gearbox as long as the sequential operating mode or manual operating mode is activated and no virtual upshift is requested by the driver.

19. The method according to claim 8, further comprising:
activating the shifting simulator in the sequential operating mode;
requesting a real downshift of the reduction gearbox; and
blocking or preventing a virtual downshift of the shifting simulator and the real downshift of the reduction gearbox as long as the sequential operating mode or manual operating mode is activated and no virtual downshift is requested either by the driver or by a virtual shift controller.

20. An electric vehicle, comprising:
a drive unit comprising at least one electric motor,
a reduction gear coupled between the drive unit and an output with at least two shiftable gears,
a shifting simulator, and
a control unit configured to match a real shift and a virtual shift.
